(19) United States
(12) Patent Application Publication
(10) Pub. No.: US 2006/0022111 A1
(43) Pub. Date: Feb. 2, 2006

(54) Article of manufacture for a removable media cartridge organization and storage system

(76) Inventor: Richard Thomas Kolensky, Suffield, CT (US)

Correspondence Address: Richard T. Kolensky, 106 Cold Spring Ln, Suffield, CT, 06078, US

(21) Appl. No.: 11/184,406

(22) Filed: Jul. 19, 2005

Related U.S. Application Data
(60) Provisional application No. 60/588,967, filed on Jul. 19, 2004.

(51) Int. Cl. A47G 29/00; F16M 11/00

(52) U.S. Cl. 248/690

(57) ABSTRACT

An article of manufacture for a removable media cartridge organization and storage system combining a plurality of adhesive tabs and an aggregating member. A preferred embodiment includes tabs made of clear plastic with a reinforced hole at the top that is attachable to a removable media cartridge via a peel-off adhesive backing. A plurality of tab-modified media cartridges may then be loaded onto an aggregating member for storage. Media cartridges are retained together in the same place. In addition, tab-modified media cartridges can still be inserted into the player while attached to the aggregating member.

### CROSS REFERENCE TO RELATED APPLICATIONS

This application is based on provisional application Ser. No. 60/588,967, filed on Jul. 19, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of video game accessories and more specifically to an article of manufacture for a removable media cartridge organization and storage system.

The popularity of handheld video game players, MP3 players, digital cameras and the like has exploded in recent years. Devices such as these (most notably Nintendo's Gameboy handheld video game system) utilize removable media cartridges to store the game, pictures, video, and/or audio that is played on said devices. These media cartridges are very small, very expensive, and—in the hands of children—very easily lost.

Users often wish to carry a plurality of removable media to watch, play with, or listen to. Most media players are only capable of accepting a single media cartridge for play at any given time. Therefore, in order to change media the user must eject one media cartridge and insert another. It is at this point where the cartridges are most-likely to be lost (between the seats, under the couch) if not returned to a means of storage.

Various prior art storage cases have been invented which store a plurality of media cartridges/disks. For example, U.S. Pat. No. 4,502,596 shows a game cartridge display and carrier pack used to carry a plurality of game cartridges which folds flat.

U.S. Pat. No. 5,899,327 shows a protective storage case for digital disks, computer game cartridges and the like.

U.S. Pat. No. 5,782,348 shows a multiple disk storage case.

Although these prior art storage cases are sufficient for the purpose for which they were intended, the storage means of the present invention improves upon the prior art by providing a means of connecting a plurality of games together (similar to keys on a keyring) in order to prevent their loss. The prior art is useful only if the user retrieves the media cartridges from and returns them to the case.

Therefore, the need exists for an improved multiple removable media storage means which attaches to the media cartridge exposing a hole which can be used to aggregate a number of media cartridges. This will alleviate the user from having to manage a given collection of media cartridges.

In addition, the ability to be able to utilize (play) the media while still attached to the aggregating member is a feature that is unique to the present invention.

### BRIEF SUMMARY OF THE INVENTION

The primary object of the invention is to provide a storage device that aggregates removable media cartridges in order to prevent their loss.

Another object of the invention is to enable a user of removable media to change media in the media player without removing the media from the aggregating member.

Another objective of the invention is to minimize the number of individual components comprising the invention contributing to the overall quality of the invention.

A further objective is to keep end-user setup and installation of the invention as simple as possible.

A still further objective of the invention is to make loading and unloading of media cartridges a one-step child-friendly process.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for a removable media cartridge organization and storage system comprising: A plurality of adhesive tabs with a reinforced hole at the top, and a carabiner-style gated ring or the like acting as the aggregating member.

In accordance with a preferred embodiment of the invention, there is disclosed a new and novel use for the adhesive hang tab

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a plan view of the prior art (tab)

FIG. 2 is a vertical side view of the prior art (tab)

FIG. 3 is a plan view of a media cartridge fitted with a tab exposing a hole at the top

FIG. 4 is a general perspective view of the present invention

FIG. 5 is a general perspective view of the preferred embodiment

FIG. 6 is a general perspective view of a prototype of the preferred embodiment

FIG. 7 is a general perspective view of an alternative embodiment of an aggregating member.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

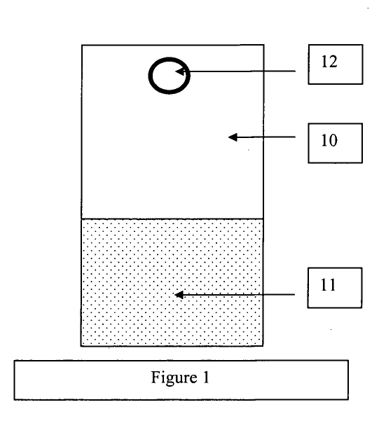

FIG. 1 shows a general perspective view of the prior art. Tab(10) with adhesive (11) and reinforced hole(12).

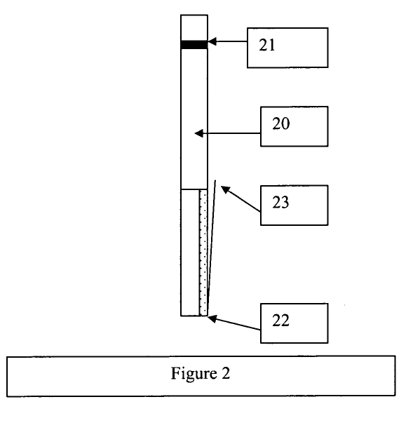

FIG. 2 shows a side view of the prior art. Tab(20) equipped with reinforced hole (21) and adhesive(22) with paper-backing (23)

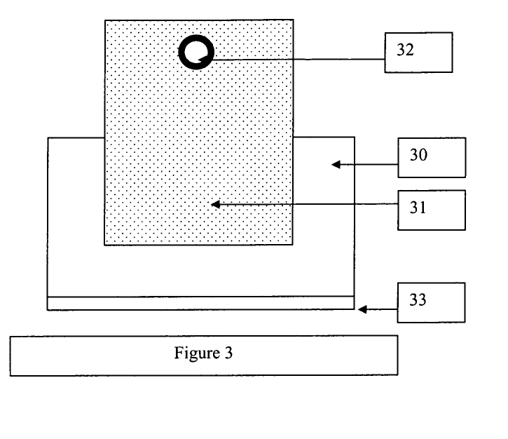

FIG. 3 shows a general perspective view of a media cartridge(30) modified by an adhesive tab(31) exposing a reinforced hole(32) at the top. (33) depicts the media player electronic interface.

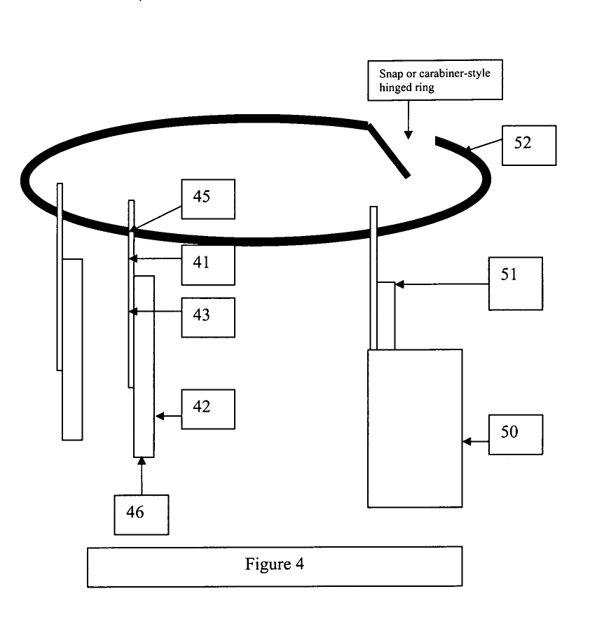

FIG. 4 is a general perspective view of a media organization and storage system.

FIG. 4 shows a preferred embodiment with a plurality of tab-modified media cartridges. One of the cartridges is depicted inside a media player.

Tab(41) is attached to media cartridge(42) via adhesive (43) leaving exposed hole at the top of the tab(45).

Game player interface(46) remains exposed so that media cartridge(42) can be inserted into the media player(50) in its tab-modified state(51).

Media cartridges are attached to aggregating member(52).

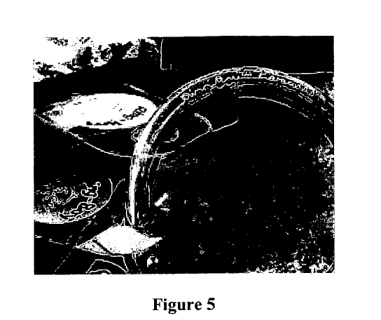

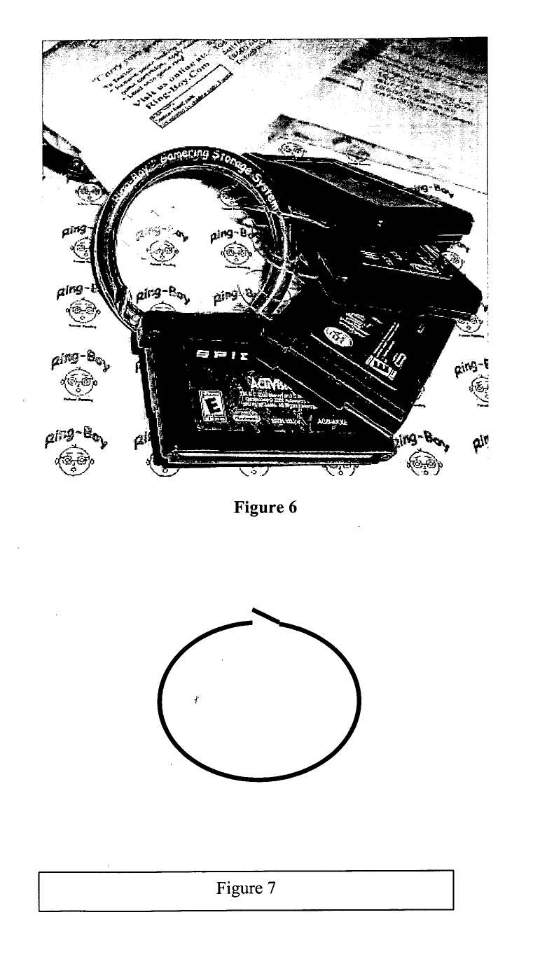

FIGS. 5 and 6 depict a prototype of the preferred embodiment.

FIG. 7 illustrates an alternate embodiment of the aggregating member. A split ring that is a closed circle when at rest. When upward force is applied to split section(80), the ring opens sufficiently enabling the ring to be loaded and/or unloaded with tab-modified media cartridge(s).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for a removable media cartridge organization and storage system comprising: An adhesive tab member exposing a reinforced hole at the top; and an aggregating member
1A. The combination of claim 1 wherein the preferred embodiment of said aggregating member is a carabiner-style connector.
1B. The combination of claim 1 wherein another embodiment of said aggregating member is a split-ring connector.
1C. The combination of claim 1 wherein said aggregating member has a thickness of at least 1/16″ less than the diameter of the hole in the tab member.
1D. The combination of claim 1 wherein said aggregating member is constructed of material such as aluminum, plastic, vinyl, rubber, or other durable, lightweight material in any color.
1E. The combination of claim 1 wherein said tab member is constructed from thin, high tensile strength plastic less than 16 mils in thickness.

2. A new and novel use for an adhesive hang tab
